(19) United States
(12) Patent Application Publication
(10) Pub. No.: US 2026/0171315 A1
(43) Pub. Date: Jun. 18, 2026

(54) MULTILAYER CAPACITOR AND METHOD OF MANUFACTURING THE SAME

(71) Applicant: SAMSUNG ELECTRO-MECHANICS CO., LTD., Suwon-si (KR)

(72) Inventors: Yu Jin So, Suwon-si (KR); Jimin Youn, Suwon-si (KR); Eunseol Bae, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/193,457

(22) Filed: Apr. 29, 2025

(30) Foreign Application Priority Data
Dec. 17, 2024 (KR) 10-2024-0188660

(51) Int. Cl. H01G 4/18; H01G 4/248; H01G 4/30

(52) U.S. Cl. CPC H01G 4/186; H01G 4/248; H01G 4/30

(57) ABSTRACT

A multilayer capacitor and a method of manufacturing the multilayer capacitor including a capacitor body including a dielectric layer and an internal electrode layer, and an external electrode disposed on an outer surface of the capacitor body, wherein the dielectric layer includes a composite dielectric material including a polyvinylidene fluoride (PVDF)-based compound and a carbon-based material, and the external electrode includes an electrode layer including an intermetallic compound (IMC) including copper (Cu) and tin (Sn), and a thermosetting epoxy resin.

### CROSS-REFERENCE TO RELATED APPLICATION

This application claims priority to and the benefit of Korean Patent Application No. 10-2024-0188660 filed with the Korean Intellectual Property Office on Dec. 17, 2024, the entire contents of which are incorporated herein by reference.

### BACKGROUND

### (a) Technical Field

The present disclosure relates to a multilayer capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, as the range of use has expanded to the vehicle electrical industry, the standards for guaranteeing flex cracks due to harsh usage environments have become stricter. MLCCs using a ceramic material as dielectric material have chronic defects such as cracks and breakage due to low body strength, and various studies are being conducted to improve this.

### SUMMARY

Some embodiments of the present disclosure provides a multilayer capacitor having excellent flexibility, durability, thermal stability, processability, and reliability.

Another embodiment provides a method of manufacturing a multilayer capacitor.

An embodiment provides a multilayer capacitor including a capacitor body including a dielectric layer and an internal electrode layer, and an external electrode disposed on an outer surface of the capacitor body, wherein the dielectric layer includes a composite dielectric material including a polyvinylidene fluoride (PVDF)-based compound and a carbon-based material, and the external electrode includes an electrode layer including an intermetallic compound (IMC) including copper (Cu) and tin (Sn), and a thermosetting epoxy resin.

The polyvinylidene fluoride (PVDF)-based compound may include one or more selected from polyvinylidene fluoride (PVDF) homopolymer, polyvinylidene fluoride (PVDF) copolymer, polyvinylidene fluoride-trifluoroethylene (PVDF-TrFE), polyvinylidene fluoride-hexafluoropropylene (PVDF-HFP), and polyvinylidene fluoride-chlorotrifluoroethylene (PVDF-CTFE).

The carbon-based material may include one or more selected from the group consisting of carbon nanotube (CNT), reduced graphene oxide (rGO), and carbon black.

The carbon-based material may be included in an amount of about 1 wt % to about 50 wt % based on a total amount of the polyvinylidene fluoride (PVDF)-based compound and the carbon-based material.

The composite dielectric material may have a form in which the carbon-based material is dispersed in a matrix of the polyvinylidene fluoride (PVDF)-based compound.

The dielectric layer may further include a self-assembly monolayer on a layer including the composite dielectric material.

The self-assembly monolayer may include one or more selected from the group consisting of polystyrene brush (PS-brush) and phenylhexyltrichlorosilane (PTS).

The intermetallic compound (IMC) may include one or more selected from the group consisting of Cu₆Sn₅ and Cu₃Sn.

The thermosetting epoxy resin may be included in an amount of about 1 wt % to about 10 wt % based on a total amount of the intermetallic compound (IMC) and the thermosetting epoxy resin.

The intermetallic compound (IMC) may further include silver (Ag).

The intermetallic compound (IMC) may be a melt of a high-melting-point metal including copper (Cu) and a low-melting-point metal including tin (Sn).

The thermosetting epoxy resin may include one or more selected from bisphenol-A epoxy resin, bisphenol-F epoxy resin, phenol novolac type epoxy resin, cresol novolac type epoxy resin, novolac modified bisphenol-A epoxy resin, and urethane modified bisphenol-A epoxy resin.

The electrode layer may further include copper (Cu).

Another embodiment provides a method of manufacturing a multilayer capacitor which includes: forming a composite dielectric material film by mixing a polyvinylidene fluoride (PVDF)-based compound and a carbon-based material; forming a conductive metal layer on the composite dielectric material film; manufacturing a capacitor body including a dielectric layer and an internal electrode layer by stacking a plurality of composite dielectric material films having the conductive metal layer formed thereon; and forming an electrode layer of an external electrode by applying and curing a paste for forming electrode layer mixed with a conductive metal, a low-melting-point metal, and a thermosetting epoxy resin on a surface of the capacitor body.

The conductive metal may include one or more selected from copper (Cu) and silver (Ag).

The low-melting-point metal may include a Sn—Ag—Cu alloy.

The multilayer capacitor according to an embodiment can have excellent flexibility and durability due to high mechanical strength and flexural strength, and have excellent processability and reliability as well as permittivity and thermal stability.

### BRIEF DESCRIPTION OF THE DRAWINGS

FIG. 1 is a perspective view showing a multilayer capacitor according to an embodiment.

FIG. 2 is a cross-sectional view of the multilayer capacitor taken along line I-I′ of FIG. 1.

FIG. 3 is a cross-sectional view of the multilayer capacitor taken along line II-II′ of FIG. 1.

FIG. 4 is an exploded perspective view illustrating the stacked structure by disassembling the capacitor body of FIG. 1.

FIG. 5 is a schematic view of the interior of the external electrode according to an embodiment.

FIG. 6 is a schematic view showing the formation process of the intermetallic compound (IMC) according to an embodiment.

FIG. 7 is a SEM (scanning electron microscope) analysis image of the external electrode according to Example 1.

FIG. 8 is an optical microscope analysis image of the external electrode according to Example 1.

FIG. 9 is a graph of XRD (X-ray diffraction analysis) of the dielectric layer according to Example 1.

FIG. 10 is a graph of XRD (X-ray diffraction analysis) of the external electrode according to Example 1.

FIG. 11 is a graph of FT-IR (Fourier transform infrared) analysis of the thermosetting epoxy resin present in the external electrode according to Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Throughout the specification, the phrase “included as main ingredient” means that among at least one component present in a region, one component has the highest content with respect to the total amount of components.

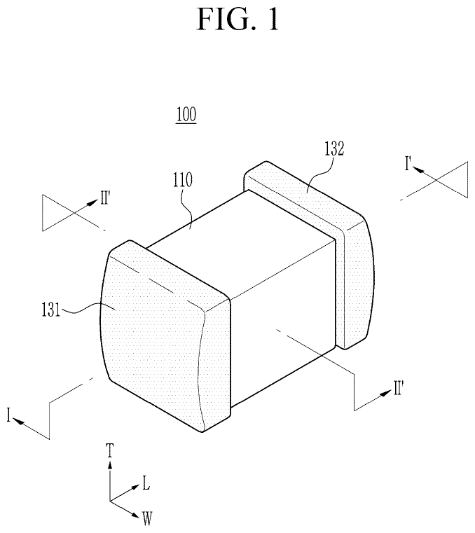

Hereinafter, a multilayer capacitor according to an embodiment will be described with reference to FIGS. 1 to 4.

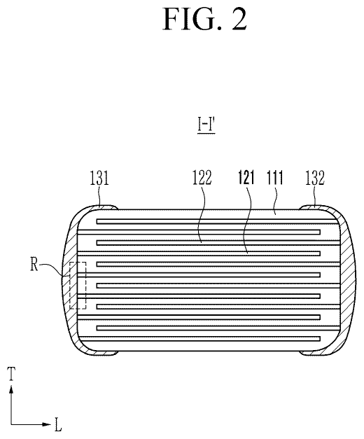

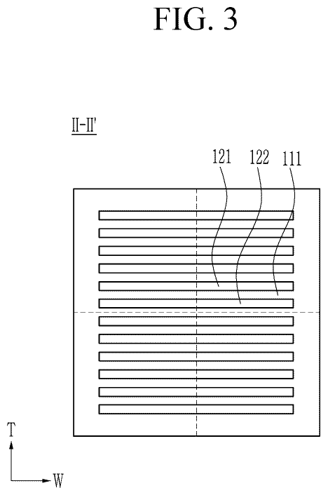

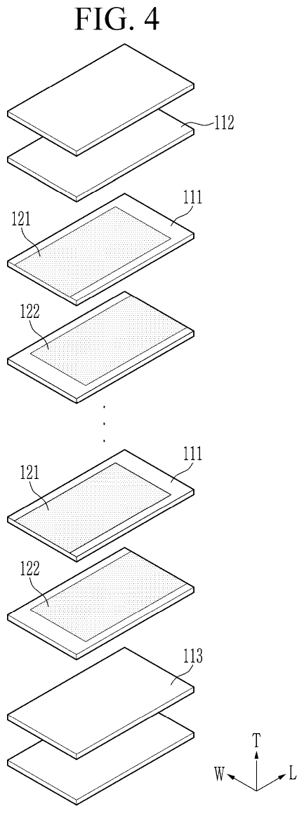

FIG. 1 is a perspective view showing a multilayer capacitor according to an embodiment, FIG. 2 is a cross-sectional view of the multilayer capacitor taken along line I-I′ of FIG. 1, FIG. 3 is a cross-sectional view of the multilayer capacitor taken along line II-II′ of FIG. 1, and FIG. 4 is an exploded perspective view illustrating the stacked structure by disassembling the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer capacitor 100 according to some embodiments includes the capacitor body 110 and external electrodes 131 and 132 disposed an outside surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 may include a plurality of dielectric layers 111 and internal electrode layers 121 and 122. Specifically, the capacitor body 110 may include the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately stacked, which contributes to forming capacitance of the multilayer capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

### Dielectric Layer

A dielectric layer 111 according to some embodiments can include a composite dielectric material including a polyvinylidene fluoride (PVDF)-based compound and a carbon-based material. That is, the composite dielectric material is a polymer dielectric material, which is distinct from a ceramic dielectric material.

Typically, multilayer capacitors use ferroelectric ceramic powder such as BaTiO₃ as the dielectric material. However, ceramic-based ferroelectric materials are heavy, brittle, and require high-temperature processing, which limits their technological utility. In particular, cracks are likely to occur when the chip is subjected to impact or tension. According to an embodiment, by applying a polymer dielectric material instead of a ceramic dielectric material to the dielectric layer, the durability of the multilayer capacitor can be improved and flexibility can be provided, thereby minimizing the occurrence of cracks.

In addition, according to some embodiments, by applying a polymer dielectric material in which a high-dielectric material is composited into a polymer matrix, it is possible to have the merits of a polymer dielectric material, such as excellent mechanical flexibility, corrosion resistance, reliability, and processability, as well as high operating voltage and high permittivity simultaneously.

That is, the multilayer capacitor according to some embodiments may be a multilayer polymer capacitor (MLPC) that uses a polymer dielectric material, which is distinguished from a multilayer ceramic capacitor (MLCC) that uses a ceramic dielectric material.

MLCCs using ceramic dielectric materials may have difficulty achieving the same high capacitance as MLPCs for the same area and volume, and have a high capacitance dependence on DC bias due to the ferroelectric material. Therefore, since the capacitance varies depending on the voltage, the capacitance may be lower than the specifications. In contrast, MLPCs using polymer dielectric materials according to an embodiment have characteristics that the capacitance does not change significantly when the voltage changes.

In addition, MLCCs using ceramic dielectric materials may have different temperature characteristics depending on the type of dielectric material, but they all exhibit temperature dependence, so they are prone to degradation, require lower operating electric fields, are fragile, and are sensitive to thermal impact. In contrast, MLPC using a polymer dielectric material according to an embodiment increases capacitance simultaneously with increasing temperature, and has relatively stable temperature characteristics due to low temperature dependence in terms of material.

Additionally, the dielectric material of MLCC may exhibit a piezoelectric effect that can induce unexpected signals in certain circuits. In some cases, electrical noise may appear due to the piezoelectric effect, whereby when a potential or electric field is applied to the surface of the MLCC, deformation may occur in the frequency range of 20 Hz to 20 kHz, which is within the audible range of humans. This is called acoustic noise or singing noise. In contrast, MLPC using a polymer dielectric material according to an embodiment can reduce acoustic noise because it does not use ceramics and thus has no piezoelectric effect.

The composite dielectric material according to some embodiments may include a polyvinylidene fluoride (PVDF)-based compound and a carbon-based material.

Specifically, the composite dielectric material may have a form in which the carbon-based material is dispersed in a matrix of the polyvinylidene fluoride (PVDF)-based compound.

The polyvinylidene fluoride (PVDF)-based compound is ferroelectric polymer that can act as a dielectric matrix. The PVDF-based compound may have high polarization and high dielectric constant due to the high electronegativity of F (fluorine) in the polymer chain and C-F dipole alignment in the crystal phase. In addition, since it has five crystal forms, it not only exhibits various characteristics depending on the crystallinity, but also may have excellent mechanical properties such as flexibility, light weight, and ease of processing, as well as high thermochemical stability.

The carbon-based material may have high dielectric constants of hundreds or more and can act as filler dispersed in the matrix of the PVDF-based compound.

As mentioned above, the PVDF-based compound may be flexible and has excellent electrical properties, but its permittivity may not be high enough to replace high-k ceramic dielectric material. According to some embodiments, a permittivity of a polymer dielectric material can be increased by using the composite dielectric material that is a composite of the PVDF-based compound and the carbon-based material, i.e., the composite dielectric material in which the carbon-based material, which may be a high-dielectric filler, may be dispersed in the matrix of the PVDF-based compound. Therefore, the multilayer capacitor applying the composite dielectric material according to some embodiments can have excellent flexibility, durability, processability, and reliability.

In some embodiments, the carbon-based material may be used as a high-dielectric filler. When dispersing ceramic powder as a high-dielectric filler in a polymer to increase the dielectric constant, there is a limit to the filling at high contents, and when the proportion of ceramic powder increases, the polymer loses flexibility and mechanical strength, resulting in a deterioration in physical properties. On the other hand, when the carbon-based material is composited with the polymer of the PVDF-based compound according to some embodiments, the shape can be stabilized even at a low concentration and the thermal, electrical and mechanical properties of the matrix of the PVDF-based compound can be increased.

Specifically, the polyvinylidene fluoride (PVDF)-based compound may include one or more selected from the group consisting of polyvinylidene fluoride (PVDF) homopolymer, polyvinylidene fluoride (PVDF) copolymer, polyvinylidene fluoride-trifluoroethylene (PVDF-TrFE), polyvinylidene fluoride-hexafluoropropylene (PVDF-HFP), and polyvinylidene fluoride-chlorotrifluoroethylene (PVDF-CTFE).

The polyvinylidene fluoride (PVDF)-based compound may be included in an amount of about 50 wt % to about 99 wt % based on a total amount of the composite dielectric material, that is, a total amount of the PVDF-based compound and the carbon-based material, for example, about 60 wt % to about 98 wt %, or about 70 wt % to about 97 wt %. When the PVDF-based compound is included in the ranges, the flexibility, durability, processability and reliability of the multilayer capacitor can be improved.

The carbon-based material may include one or more selected from the group consisting of carbon nanotube (CNT), reduced graphene oxide (rGO), and carbon black, for example, carbon nanotube (CNT).

The carbon nanotube (CNT) may be extremely fine cylindrical material that typically have an aspect ratio of tens to thousands. The carbon nanotube (CNT) has a thermal conductivity nearly twice that of diamond, a current carrying capacity approximately 1,000 times higher than that of copper (Cu), and can dramatically improve physical properties even at low concentration.

The carbon nanotube (CNT) can be a single-walled CNT, a double-walled CNT, a multi-walled CNT, a bundled CNT, or a mixture thereof.

The carbon-based material may be included in an amount of about 1 wt % to about 50 wt % based on a total amount of the composite dielectric material, that is, a total amount of the PVDF-based compound and the carbon-based material, for example, about 2 wt % to about 40 wt %, or about 3 wt % to about 30 wt %. When the carbon-based material is included in the ranges, it has sufficient filling effect and excellent dispersibility, so that the permittivity of the polymer dielectric material, which is the composite dielectric material, can be increased, and the flexibility, durability, processability, and reliability of the multilayer capacitor can be improved.

Material information of the composite dielectric material can be obtained by performing XRD (X-ray diffraction analysis) on the dielectric layer 111.

Specifically, after the multilayer capacitor 100 is placed into an epoxy mixture liquid and then cured, the W-axis and the T-axis directional surface (WT surface) of the capacitor body 110 is polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, X-ray diffraction analysis (XRD) can be performed on the dielectric layer in the active region of the cross-sectional sample using Cu Kα lines. For example, when the active region of the cross-sectional sample is divided into three regions, the upper region, the middle region, and the lower region, X-ray diffraction analysis (XRD) can be performed on the dielectric layer in each region using Cu Kα lines.

XRD analysis results show that, for example, the characteristic peak of (002) of carbon-based material strongly appears at 2θ of 25° to 27°, and the characteristic peak of (110) of PVDF-based compound strongly appears at 2θ of 19° to 21°.

When the composite dielectric material is formed as a layer, the dielectric layer (111) may further include a self-assembly monolayer to reduce the interface resistance with the internal electrode layers (121, 122) on the layer including the composite dielectric material.

The self-assembly monolayer may include one or more selected from the group consisting of polystyrene brush (PS-brush) and phenylhexyltrichlorosilane (PTS).

An average thickness (average length in the T-axis direction) of the dielectric layer 111 may be about 0.1 μm to about 8.0 μm, and for example, may be about 0.1 μm to about 6.0 μm. When the average thickness of the dielectric layer 111 is within the above range, the reliability of the multilayer capacitor may be improved.

The average thickness of the dielectric layer 111 may be measured by placing the multilayer capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. This may be an arithmetic mean value obtained by taking the central point of the length direction (L-axis direction) or width direction (W-axis direction) of the dielectric layer 111 as a reference point in the scanning electron microscope (SEM) image of the cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

### Internal Electrode Layer

The internal electrode layers 121 and 122, i.e., the first internal electrode layer 121 and the second internal electrode layer 122, are electrodes having different polarities and may be alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 may include a conductive metal, and may include, for example, one or more selected from the group consisting of Al, Cu, Sn, Ni, and an alloy thereof.

The internal electrode layers 121 and 122 can be formed by a vapor deposition method using the conductive metal on the composite dielectric material forming the dielectric layer 111.

Each average thickness of the first internal electrode layer 121 and the second internal electrode layer 122 may be about 0.1 μm to about 2 μm.

The average thickness of the first internal electrode layer 121 and the second internal electrode layer 122 may be measured by scanning electron microscope (SEM) analysis. This may be an arithmetic mean value obtained by taking the central point of the length direction (L-axis direction) or width direction (W-axis direction) of each of the internal electrode layers 121 and 122 as a reference point in the scanning electron microscope (SEM) image of the cross-sectional sample obtained by the same method as the method for measuring the average thickness of the dielectric layer 111, and taking the arithmetic mean value of the thickness of each of the internal electrode layers 121 and 122 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted.

The capacitor body 110 may be formed by firing a stacking structure in which the plurality of dielectric layers 111 and internal electrode layers 121 and 122 are stacked.

### External Electrode

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, respectively, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

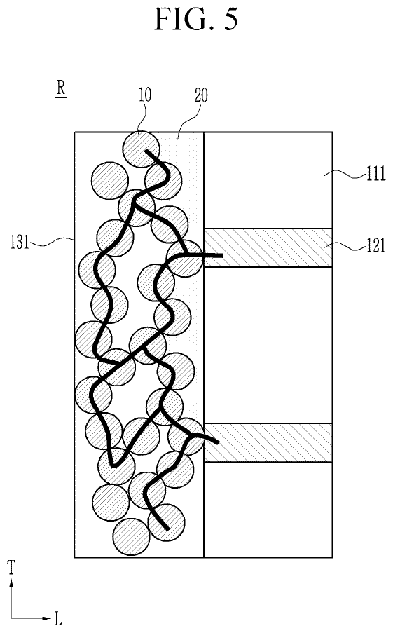

The external electrode 131 according to an embodiment are described with reference to FIG. 5. FIG. 5 describes the external electrode 131, but the same applies to the external electrode 132.

FIG. 5 is a schematic view of the interior of the external electrode according to some embodiments.

Referring to FIG. 5, the external electrode 131 may include an electrode layer including an intermetallic compound (IMC) 10 and a thermosetting epoxy resin 20. The electrode layer refers to a layer that is electrically connected to the internal electrode layers 121 and 122 within the external electrodes 131 and 132, specifically, a layer that is in direct contact with the capacitor body 110.

The intermetallic compound 10 may be a substance in which two or more metal elements are combined in a simple integer ratio, and may be a substance in which a low-melting-point metal and a high-melting-point metal melt each other at a high temperature to form a network.

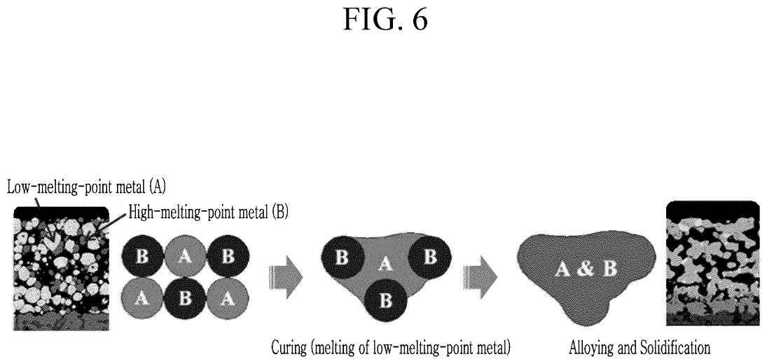

FIG. 6 is a schematic view showing the formation process of the intermetallic compound (IMC) according to some embodiments.

As shown in FIG. 6, the intermetallic compound 10 can be formed by heat-treating a low-melting-point metal A and a high-melting-point metal B at a high temperature, for example, about 200° C. to about 300° C., so that the low-melting-point metal A melts first and is hardened, and then undergoes an alloying and solidification process together with the high-melting-point metal B.

In other words, the intermetallic compound 10 may be formed by melting the low-melting-point metal and the high-melting-point metal. The low-melting-point metal may include tin (Sn). For example, the low-melting-point metal may include tin (Sn), silver (Ag), and copper (Cu), such as a Sn—Ag—Cu alloy. For example, the high-melting-point metal may include one or more selected from copper (Cu) and silver (Ag).

The intermetallic compound 10 formed by melting the low-melting-point metal and the high-melting-point metal at high temperature increases the connectivity between the external electrodes 131 and 132 and the internal electrodes 121 and 122. In addition, as shown in FIG. 5, the intermetallic compound 10 enables the function of electrodes of an electron transfer by connecting the external electrodes 131 and 132 and the internal electrodes 121 and 122, and a dense network is formed to produce an anchoring effect between the electrodes.

The intermetallic compound 10 may include copper (Cu) and tin (Sn). For example, the intermetallic compound 10 may include one or more selected from the group consisting of Cu₆Sn₅ and Cu₃Sn.

Additionally, the intermetallic compound 10 may further include silver (Ag).

The external electrodes 131 and 132 according to some embodiments may include the intermetallic compound 10 described above, thereby lowering the Young's modulus compared to a general copper (Cu) electrode, thereby increasing elasticity and improving the flexural strength characteristics.

The intermetallic compound 10 may be included in an amount of about 90 wt % to about 99 wt % based on a total amount of the intermetallic compound 10 and the thermosetting epoxy resin 20, for example, about 91 wt % to about 98 wt %, or about 92 wt % to about 97 wt %. When the intermetallic compound is included in the above content range, the connectivity between the internal electrode layer and the external electrode can be increased.

The thermosetting epoxy resin 20 may be a thermosetting resin having an epoxy group in the polymer. For example, the thermosetting epoxy resin 20 may include one or more selected from the group consisting of bisphenol-A epoxy resin such as bisphenol-A epichlorohydrin epoxy resin; bisphenol-F epoxy resin; phenol novolac type epoxy resin; cresol novolac type epoxy resin; novolac modified bisphenol-A epoxy resin; and urethane modified bisphenol-A epoxy resin.

Since the thermosetting epoxy resin 20 has a very low Young's modulus, the flexural strength characteristics can be further improved.

The thermosetting epoxy resin 20 may be included in an amount of about 1 wt % to about 10 wt % based on a total amount of the intermetallic compound 10 and the thermosetting epoxy resin 20, for example, about 2 wt % to about 9 wt %, or about 3 wt % to about 8 wt %. When the thermosetting epoxy resin is included in the above content range, the flexural strength and elasticity increase, so that a multilayer capacitor with excellent flexibility and durability can be obtained.

According to some embodiments, the multilayer capacitor using the dielectric layer 111 using a polymer dielectric material of the composite dielectric material including the PVDF-based compound and the carbon-based material, and the external electrodes 131 and 132 including the intermetallic compound (IMC) and the thermosetting epoxy resin, not only has a high dielectric constant, but also has high flexural strength and elasticity, so that flexibility and durability are excellent and processability and reliability can be improved.

The electrode layer of the external electrodes 131 and 132 may further include copper (Cu).

The structure and components of the external electrodes 131 and 132 can be determined by SEM (scanning electron microscope) and optical microscope analysis, XRD (X-ray diffraction analysis), and FT-IR (Fourier transform infrared) analysis.

SEM (scanning electron microscope) analysis can be performed as follows. Specifically, after the multilayer capacitor 100 is placed into the epoxy mixture liquid and then cured, the W-axis and the T-axis directional surface (WT surface) of the capacitor body 110 is polished to ½ depth in the L-axis direction, a cross-sectional sample may be obtained such that the external electrodes may be observed. Next, one side of the external electrode in the cross-sectional sample can be measured using a scanning electron microscope (SEM). For example, SEM can be measured at an accelerating voltage of 10 kV and a magnification of 2000×.

Optical microscopy analysis can be performed at 100× magnification on a cross-sectional sample obtained by the method described above, so that one side of the external electrode is visible.

Through the SEM analysis and the optical microscope analysis, it can be confirmed that the thermosetting epoxy resin and the intermetallic compound (IMC) exist within the electrode layer of the external electrode, specifically, the external electrode in contact with a surface of the capacitor body, i.e., the two materials exist separately from each other.

Additionally, X-ray diffraction analysis (XRD) can be performed on one side of the external electrode using Cu Kα lines on the cross-sectional sample obtained by the above-described method. XRD analysis results show that peaks corresponding to intermetallic compounds (IMCs) such as Cu₆Sn₅ and Cu₃Sn strongly appear at 2θ of 40° to 45°.

Additionally, FT-IR analysis can be performed in the range of 4000 cm⁻¹ to 650 cm 1 with an FT-IR spectrometer (Fourier-transform infrared spectroscopy). FT-IR analysis results confirm the presence of the thermosetting epoxy resin within the electrode layer of the external electrode through the presence of C—H bond, C—C bond, and C—O—C bond.

When forming an external electrode with a polymer such as a thermosetting epoxy resin, drying and curing are performed at high temperatures. At this time, dipole-dipole interaction is created at the interface between the PVDF-based compound of the dielectric layer and the Cu metal present in the external electrode. When δ− polarization occurs around the Cu metal, TTT conformation occurs in a phase corresponding to δ+ polarization of the PVDF-based compound. This means that a hermetic sealing effect that enables perfect sealing can be expected by increasing the bonding strength through a chemical reaction between the PVDF-based compound of the dielectric layer and Cu in the external electrode.

That is, according to some embodiments, the contact between the capacitor body including the dielectric layer and the external electrode disposed on the outer surface of the capacitor body can be improved. In other words, the contact between the dielectric layer composed of the composite dielectric material including the PVDF-based compound and the carbon-based material and the external electrode including the intermetallic compound (IMC) and the thermosetting epoxy resin can be improved.

According to some embodiments, the multilayer capacitor using the dielectric layer using the above-described polymer dielectric material and the external electrode including the intermetallic compound and the thermosetting epoxy resin together has excellent flexibility and durability due to high flexural strength and elasticity, and can have improved reliability due to mitigation of physical impact by application of the polymer dielectric material. In addition, since a firing process essential for manufacturing multilayer ceramic capacitor can be omitted, processability can be improved, and since variables such as particle dispersion within the internal electrode layer and firing mismatch that may occur in the firing process at 1000° C. or higher can be eliminated, reliability can be improved.

In addition to the electrode layer described above, the external electrodes 131 and 132 may additionally include a conductive resin layer disposed to cover the electrode layer, and a plating layer disposed to cover the conductive resin layer.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the electrode layer is extended and disposed to the first and second surfaces or the fifth and sixth surfaces of the capacitor body 110. That is, the conductive resin layer may be formed on the electrode layer, and may be formed in the shape that completely covers the electrode layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the electrode layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer capacitor 100.

### Method of Manufacturing Multilayer Capacitor

Hereinafter, a method of manufacturing the multilayer capacitor 100 according to some embodiments will be described.

A multilayer capacitor 100 according to some embodiments may be manufactured by forming a composite dielectric material film by mixing a polyvinylidene fluoride (PVDF)-based compound and a carbon-based material; forming a conductive metal layer on the composite dielectric material film; manufacturing a capacitor body including a dielectric layer and an internal electrode layer by stacking a plurality of composite dielectric material films having the conductive metal layer formed thereon; and forming an electrode layer of an external electrode by applying and curing a paste for forming electrode layer mixed with a conductive metal, a low-melting-point metal, and a thermosetting epoxy resin on a surface of the capacitor body.

In the step of forming the composite dielectric material film, the composite dielectric material film can be formed by mixing a PVDF-based compound into a dispersion liquid in which a carbon-based material is dispersed in a solvent, and then subjecting the mixture liquid to a casting process and a drying process. Since the PVDF-based compound and the carbon-based material are the same as described above, their description is omitted here.

The PVDF-based compound and the carbon-based material can be mixed at a weight ratio of about 50:50 to about 99:1, for example, at a weight ratio of about 60:40 to about 98:2, or at a weight ratio of about 70:30 to about 97:3. When mixing within the above weight ratio range, a multilayer capacitor having excellent flexibility, durability, processability, and reliability can be obtained.

In the step of forming the conductive metal layer, the conductive metal layer may include one or more conductive metal selected from the group consisting of aluminum (AI), copper (Cu), tin (Sn), nickel (Ni), and alloys thereof. The conductive metal layer can be formed on the composite dielectric material film by a vapor deposition method.

In the step of forming the electrode layer of the external electrode, the paste for forming electrode layer can be prepared by mixing a conductive metal, a low-melting-point metal, and a thermosetting epoxy resin.

The conductive metal may be a high-melting-point metal, and for example, may include one or more selected from the group consisting of copper (Cu) and silver (Ag). The low-melting-point metal may include tin (Sn), and for example, may include tin (Sn), silver (Ag) and copper (Cu), and for example, may include a Sn—Ag—Cu alloy. The conductive metal corresponding to the high-melting-point metal and the low-melting-point metal can melt together at high temperatures to form the aforementioned intermetallic compound (IMC).

The conductive metal and the low-melting-point metal can be mixed in a weight ratio of about 3:7 to about 7:3.

Since the thermosetting epoxy resin is the same as described above, its description is omitted here.

The thermosetting epoxy resin can be mixed in an amount of about 1 parts by weight to about 20 parts by weight based on 100 parts by weight of the total amount of the conductive metal and the low-melting-point metal.

The paste for forming electrode layer may additionally include a binder, a solvent, a dispersant, a plasticizer, oxide powder, etc. The binder may be, for example, ethyl cellulose, acrylic, butyral, etc., and the solvent may be, for example, an organic solvent such as terpineol, butyl carbitol, alcohol, methyl ethyl ketone, acetone, toluene, etc., or an aqueous solvent.

Methods for applying the paste for forming electrode layer on the outer surface of the capacitor body 110 may include various printing methods such as dip method and screen printing, application method using a dispenser, etc., and spraying method using spray. The paste for forming electrode layer may be applied to at least the third and fourth surfaces of the capacitor body 110, and optionally applied to a part of the first, second, fifth, or the sixth surfaces on which the band portions of the first and second external electrodes are formed.

After applying the paste for forming electrode layer, it can be dried at about 100° C. to about 160° C., and then cured at a temperature of about 200° C. to about 300° C.

Optionally, a paste for forming conductive resin layer is applied on an outer surface of the obtained capacitor body 110 and then cured, to form the conductive resin layer.

The paste for forming conductive resin layer may include a resin and, optionally, a conductive metal or a non-conductive filler. Since the description of the conductive metal and resin is the same as described above, repetitive description will be omitted. Additionally, the paste for forming conductive resin layer may optionally include a binder, a solvent, a dispersant, a plasticizer, an oxide powder, and the like. The binder may be, for example, ethylcellulose, acrylic, butyral, etc., and the solvent may be an organic solvent such as terpineol, butylcarbitol, alcohol, methyl ethyl ketone, acetone, and toluene, or aqueous solvent.

For example, the conductive resin layer may be formed by dipping the capacitor body 110 in the paste for forming conductive resin layer and then curing it, or by printing the paste for forming conductive resin layer on the surface of the capacitor body 110 by a screen-printing method or a gravure printing method, or by applying the paste for forming conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Capacitors)

### Examples 1 to 3

A composite dielectric material film was formed by mixing polyvinylidene fluoride (PVDF) into a dispersion liquid in which carbon nanotube (CNT) was dispersed in a solvent, and then subjecting the mixture liquid to a casting process and a drying process. At this time, PVDF and CNT were mixed at the weight ratio shown in Table 1 below.

Next, nickel (Ni) was vapor deposited on the composite dielectric material film to form a conductive metal layer.

Next, a capacitor body was manufactured by stacking the composite dielectric material film having the conductive metal layer formed thereon.

Next, an IMC paste was prepared by mixing Cu powder, Sn_{96.5}Ag_{3.0}Cu_{0.5} (SAC) alloy powder, and bisphenol-A epichlorohydrin epoxy resin. At this time, the Cu powder and the SAC alloy powder were mixed at a weight ratio of 1:1, and the bisphenol-A epoxy resin was mixed at 5 parts by weight based on 100 parts by weight of the total amount of the Cu powder and the SAC alloy powder. The prepared paste was applied to a surface of the capacitor body using a dip coating method, dried at 100° C., and then cured at 240° C. to form an electrode layer of an external electrode.

Subsequently, each multilayer capacitor was manufactured through processes such as plating.

### Examples 4 to 6

Each multilayer capacitor was manufactured in the same manner as in Examples 1 to 3, except that polyvinylidene fluoride-trifluoroethylene (PVDF-TrFE) was used instead of PVDF in Examples 1 to 3 to form a composite dielectric material film.

### Comparative Example 1

A multilayer capacitor was manufactured in the same manner as in Example 1, except that a composite dielectric material film was formed without using the CNT.

### Comparative Example 2

A multilayer capacitor was manufactured in the same manner as in Example 4, except that a composite dielectric material film was formed without using the CNT.

### Comparative Example 3

A multilayer capacitor was manufactured in the same manner as in Example 1, except that an electrode layer of an external electrode was formed using Cu paste instead of the paste of Example 1.

Cu paste was prepared by mixing 70 wt % of Cu powder, 20 wt % of glass composition, 5 wt % of acrylic resin (SPB 80), and the remainder of dihydroterpineol (DHT). At this time, the glass composition includes 9.0 mol % of Li₂O, 10 mol % of Na₂O, 1.5 mol % of Fe₂O₃, 6.3 mol % of ZnO, 21 mol % of BaO, 11 mol % of SiO₂, 8 mol % of CaO, 12 mol % of Al₂O₃, 20.2 mol % of B₂O₃, and 1 mol % of SnO₂.

### Comparative Example 4

A multilayer capacitor was manufactured in the same manner as in Example 4, except that an electrode layer of an external electrode was formed using Cu paste instead of the paste of Example 4.

Cu paste was prepared by mixing 70 wt % of Cu powder, 20 wt % of glass composition, 5 wt % of acrylic resin (SPB 80), and the remainder of dihydroterpineol (DHT). At this time, the glass composition includes 9.0 mol % of Li₂O, 10 mol % of Na₂O, 1.5 mol % of Fe₂O₃, 6.3 mol % of ZnO, 21 mol % of BaO, 11 mol % of SiO₂, 8 mol % of CaO, 12 mol % of Al₂O₃, 20.2 mol % of B₂O₃, and 1 mol % of SnO₂.

TABLE 1

| | | | Electrode layer of |
|---|---|---|---|
| | Dielectric layer | | external electrode |
| Example 1 | PVDF 95 wt % | CNT 5 wt % | IMC paste |
| Example 2 | PVDF 90 wt % | CNT 10 wt % | IMC paste |
| Example 3 | PVDF 85 wt % | CNT 15 wt % | IMC paste |
| Example 4 | PVDF-TrFE 95 wt % | CNT 5 wt % | IMC paste |
| Example 5 | PVDF-TrFE 90 wt % | CNT 10 wt % | IMC paste |
| Example 6 | PVDF-TrFE 85 wt % | CNT 15 wt % | IMC paste |
| Comparative | PVDF | — | IMC paste |
| Example 1 | | | |
| Comparative | PVDF-TrFE | — | IMC paste |
| Example 2 | | | |
| Comparative | PVDF 95 wt % | CNT 5 wt % | Cu paste |
| Example 3 | | | |
| Comparative | PVDF-TrFE 95 wt % | CNT 5 wt % | Cu paste |
| Example 4 | | | |

### Evaluation 1: SEM and Optical Microscope Analysis

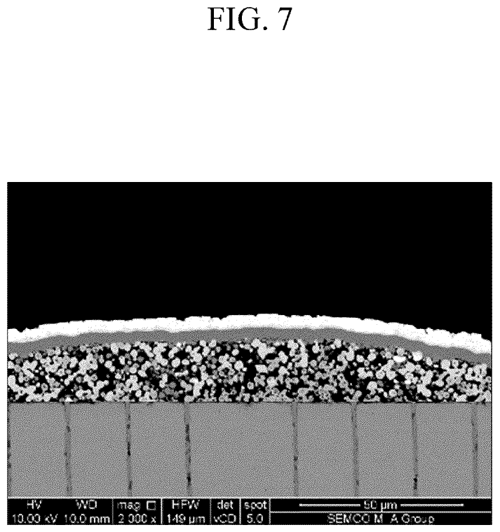

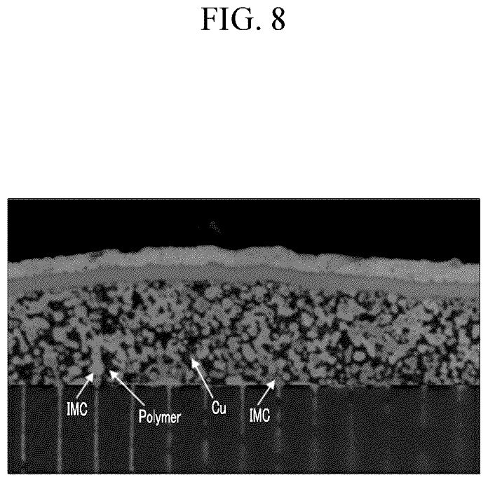

SEM (scanning electron microscope) and optical microscope analysis were performed on the multilayer capacitor manufactured in Example 1, and the results are shown in FIGS. 7 and 8.

For SEM analysis, the cross-sectional sample was obtained by placing the multilayer capacitor in an epoxy mixture, curing it, and then polishing the W-axis and the T-axis directional surface (WT surface) of the capacitor body to a depth of ½ in the L-axis direction so that the external electrodes could be observed. Subsequently, SEM analysis was performed at an acceleration voltage of 10 kV and a magnification of 2000× to visualize the external electrode on one side of the cross-sectional sample. Additionally, optical microscope analysis was performed at 100× magnification to visualize the external electrode on one side of the cross-sectional sample.

FIG. 7 is a SEM (scanning electron microscope) analysis image of the external electrode according to Example 1, and FIG. 8 is an optical microscope analysis image of the external electrode according to Example 1.

Referring to FIGS. 7 and 8, it can be seen that a polymer such as a thermosetting epoxy resin and an intermetallic compound (IMC) exist within the electrode layer of the external electrode, i.e., the two materials exist separately from each other.

### Evaluation 2: XRD Analysis

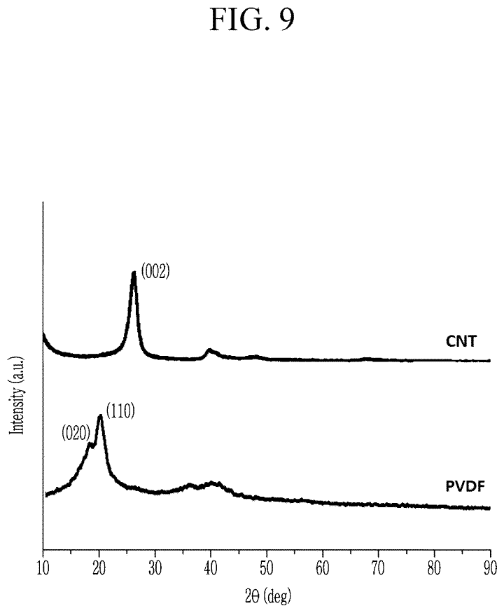

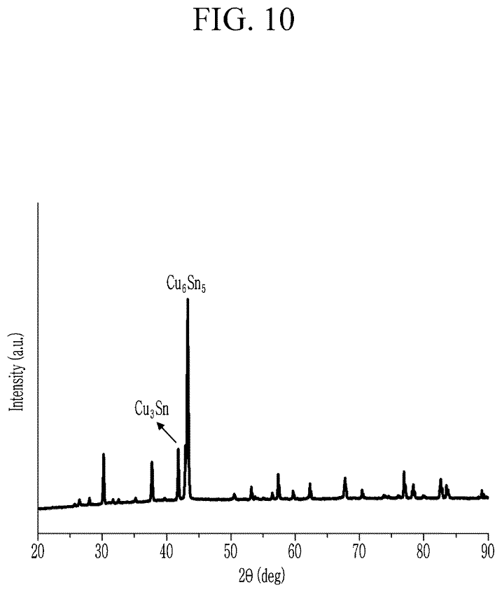

X-ray diffraction analysis (XRD) was performed on the multilayer capacitor manufactured in Example 1, and the results are shown in FIGS. 9 and 10.

After the multilayer capacitor was placed in an epoxy mixture and cured, the W-axis and T-axis direction surface (WT surface) of the capacitor body was polished to a depth of ½ in the L-axis direction, fixed, and maintained in a vacuum atmosphere chamber to obtain a cross-sectional sample so that the active region where the dielectric layer and the internal electrode layer intersect could be observed. X-ray diffraction (XRD) analysis was performed on the dielectric layer in the active region of the obtained cross-sectional sample using Cu Kα line.

FIG. 9 is a graph of XRD (X-ray diffraction analysis) of the dielectric layer according to Example 1.

Referring to FIG. 9, the characteristic peak of carbon nanotube (CNT) of (002) can be confirmed at 2θ of 25° to 27°, and the characteristic peak of polyvinylidene fluoride (PVDF) of (110) can be confirmed at 2θ of 19° to 21°. Accordingly, it can be seen that the composite dielectric material within the dielectric layer is composed of PVDF and CNT.

Additionally, X-ray diffraction (XRD) analysis was performed on the cross-sectional sample obtained in Evaluation 1 using Cu Kα line for one side of the external electrode.

FIG. 10 is a graph of XRD (X-ray diffraction analysis) of the external electrode according to Example 1.

Referring to FIG. 10, the characteristic peaks of Cu₆Sn₅ and Cu₃Sn can be confirmed at 20 of 40° to 45°. Accordingly, it can be seen that the intermetallic compound (IMC) containing Cu and Sn exists in the electrode layer of the external electrode.

### Evaluation 3: FT-IR Analysis

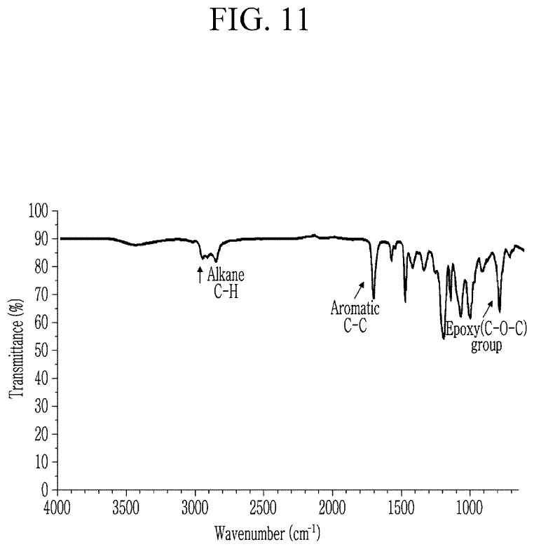

FT-IR (Fourier transform infrared) analysis was performed on the multilayer capacitor manufactured in Example 1, and the results are shown in FIG. 11.

FT-IR analysis was performed using a Fourier-transform infrared (FT-IR) spectroscopy in the range of 4000 cm⁻¹ to 650 cm⁻¹.

FIG. 11 is a graph of FT-IR (Fourier transform infrared) analysis of the thermosetting epoxy resin present in the external electrode according to Example 1.

Referring to FIG. 11, the thermosetting epoxy resin within the electrode layer of the external electrode can be confirmed through the presence of C—H bond, C—C bond, and C—O—C bond.

### Evaluation 4: Physical Property Measurement

### (1) Mechanical Properties Measurement

Mechanical properties such as strength and elasticity were measured for the multilayer capacitors manufactured in Examples 1 to 6 and Comparative Examples 1 to 4, and the results are shown in Table 2 below.

Both strength and modulus were measured according to ASTM D638 reference.

### (2) Thermal Stability

TGA (thermogravimetric analysis) was performed on the multilayer capacitors manufactured in Examples 1 to 6 and Comparative Examples 1 to 4, and the results are shown in Table 2 below.

TGA was performed under a nitrogen atmosphere at a heating rate of 10° C./min from 25° C. to 800° C., and the value of Td, 10% was measured. Td, 10% represents the temperature when 10 wt % of the substance involved in the analysis is lost.

### (3) Permittivity

Permittivities of the multilayer capacitors manufactured in Examples 1 to 6 and Comparative Examples 1 to 4 were measured, and the results are shown in Table 2 below.

The permittivity was measured at 100 Hz using an impedance analyzer.

### (4) Flexural Strength

The flexural strength of the multilayer capacitors manufactured in Examples 1 to 6 and Comparative Examples 1 to 4 was measured, and the results are shown in Table 2 below.

The flexural strength was tested by mounting 30 sample chips on a flexural strength substrate, maintaining the chip at 10 mm for 10 seconds, and then checking for cracks. The flexural strength was expressed as the number (ea) of cracks that occurred among 30 sample chips.

TABLE 2

| | | | Thermal | | | |
|---|---|---|---|---|---|---|
| | | | stability | | | |
| | Strength | Modulus | (T_{d, 10%}) | | Flexural | |
| | (MPa) | (GPa) | (° C.) | Permittivity | strength | |
| Example 1 | 215 | 3.7 | 453 | 295 | 0/30 | ea |
| Example 2 | 222 | 4.1 | 456 | 217 | 0/30 | ea |
| Example 3 | 234 | 5.2 | 458 | 198 | 0/30 | ea |
| Example 4 | 203 | 3.5 | 455 | 437 | 0/30 | ea |
| Example 5 | 219 | 3.6 | 459 | 388 | 0/30 | ea |
| Example 6 | 220 | 4.6 | 460 | 170 | 0/30 | ea |
| Comparative | 198 | 3.5 | 448 | 9.8 | 5/30 | ea |
| Example 1 | | | | | | |
| Comparative | 41 | 2.7 | 451 | 14 | 4/30 | ea |
| Example 2 | | | | | | |
| Comparative | 215 | 3.7 | 453 | 295 | 17/30 | ea |
| Example 3 | | | | | | |
| Comparative | 203 | 3.5 | 455 | 437 | 19/30 | ea |
| Example 4 | | | | | | |

Through the above Table 2, it can be seen that the mechanical strength, thermal stability, permittivity, and flexural strength of Examples 1 to 6 are all superior to those of Comparative Examples 1 to 4. That is, it can be seen that Comparative Examples 1 and 2 have reduced permittivity and flexural strength, and Comparative Examples 3 and 4 have significantly reduced flexural strength.

From this, it can be seen that the multilayer capacitor having the dielectric layer using the composite dielectric material including the PVDF-based compound and the carbon-based material and the electrode layer of the external electrode including the intermetallic compound (IMC) including Cu and Sn and the thermosetting epoxy resin, according to an embodiment, has high mechanical strength and flexural strength, thus exhibiting excellent flexibility and durability, and has excellent processability and reliability as well as permittivity and thermal stability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: intermetallic compound (IMC)
20: thermosetting epoxy resin
100: multilayer capacitor
110: capacitor body
111: dielectric layer
121: first internal electrode layer
122: second internal electrode layer
131: first external electrode
132: second external electrode

What is claimed is:

1. A multilayer capacitor, comprising
a capacitor body including a dielectric layer and an internal electrode layer, and
an external electrode disposed on an outer surface of the capacitor body,
wherein the dielectric layer comprises a composite dielectric material including a polyvinylidene fluoride (PVDF)-based compound and a carbon-based material, and
the external electrode comprises an electrode layer including an intermetallic compound (IMC) including copper (Cu) and tin (Sn), and a thermosetting epoxy resin.

2. The multilayer capacitor of claim 1, wherein
the polyvinylidene fluoride (PVDF)-based compound comprises one or more selected from the group consisting of polyvinylidene fluoride (PVDF) homopolymer, polyvinylidene fluoride (PVDF) copolymer, polyvinylidene fluoride-trifluoroethylene (PVDF-TrFE), polyvinylidene fluoride-hexafluoropropylene (PVDF-HFP), and polyvinylidene fluoride-chlorotrifluoroethylene (PVDF-CTFE).

3. The multilayer capacitor of claim 1, wherein
the carbon-based material comprises one or more selected from the group consisting of carbon nanotube (CNT), reduced graphene oxide (rGO), and carbon black.

4. The multilayer capacitor of claim 1, wherein
the dielectric layer comprises the carbon-based material in an amount of 1 wt % to 50 wt % based on a total amount of the polyvinylidene fluoride (PVDF)-based compound and the carbon-based material.

5. The multilayer capacitor of claim 1, wherein
the composite dielectric material has a structure in which the carbon-based material is dispersed in a matrix of the polyvinylidene fluoride (PVDF)-based compound.

6. The multilayer capacitor of claim 1, wherein
the dielectric layer further comprises a self-assembly monolayer on a layer including the composite dielectric material.

7. The multilayer capacitor of claim 6, wherein
the self-assembly monolayer comprises one or more selected from the group consisting of polystyrene brush (PS-brush) and phenylhexyltrichlorosilane (PTS).

8. The multilayer capacitor of claim 1, wherein
the intermetallic compound (IMC) comprises one or more selected from the group consisting of Cu₆Sn₅ and Cu₃Sn.

9. The multilayer capacitor of claim 1, wherein
the external electrode includes the thermosetting epoxy resin in an amount of 1 wt % to 10 wt % based on a total amount of the intermetallic compound (IMC) and the thermosetting epoxy resin.

10. The multilayer capacitor of claim 1, wherein
the intermetallic compound (IMC) further comprises silver (Ag).

11. The multilayer capacitor of claim 1, wherein
the intermetallic compound (IMC) is a melt of a high-melting-point metal including copper (Cu) and a low-melting-point metal including tin (Sn).

12. The multilayer capacitor of claim 11, wherein
the low-melting-point metal comprises a Sn—Ag—Cu alloy.

13. The multilayer capacitor of claim 1, wherein
the thermosetting epoxy resin comprises one or more selected from the group consisting of bisphenol-A epoxy resin, bisphenol-F epoxy resin, phenol novolac type epoxy resin, cresol novolac type epoxy resin, novolac modified bisphenol-A epoxy resin, and urethane modified bisphenol-A epoxy resin.

14. The multilayer capacitor of claim 1, wherein
the electrode layer further comprises copper (Cu).

15. A method of manufacturing a multilayer capacitor, comprising
forming a composite dielectric material film by mixing a polyvinylidene fluoride (PVDF)-based compound and a carbon-based material;
forming a conductive metal layer on the composite dielectric material film;
manufacturing a capacitor body including a dielectric layer and an internal electrode layer by stacking a plurality of composite dielectric material films having the conductive metal layer formed thereon; and
forming an electrode layer of an external electrode by applying and curing a paste for forming electrode layer mixed with a conductive metal, a low-melting-point metal, and a thermosetting epoxy resin on a surface of the capacitor body.

16. The method of claim 15, wherein
the polyvinylidene fluoride (PVDF)-based compound comprises one or more selected from the group consisting of polyvinylidene fluoride (PVDF) homopolymer, polyvinylidene fluoride (PVDF) copolymer, polyvinylidene fluoride-trifluoroethylene (PVDF-TrFE), polyvinylidene fluoride-hexafluoropropylene (PVDF-HFP), and polyvinylidene fluoride-chlorotrifluoroethylene (PVDF-CTFE).

17. The method of claim 15, wherein
the carbon-based material comprises one or more selected from the group consisting of carbon nanotube (CNT), reduced graphene oxide (rGO), and carbon black.

18. The method of claim 15, wherein
the conductive metal comprises one or more selected from the group consisting of copper (Cu) and silver (Ag).

19. The method of claim 15, wherein
the low-melting-point metal comprises a Sn—Ag—Cu alloy.

20. The method of claim 15, wherein
the thermosetting epoxy resin comprises one or more selected from the group consisting of bisphenol-A epoxy resin, bisphenol-F epoxy resin, phenol novolac type epoxy resin, cresol novolac type epoxy resin, novolac modified bisphenol-A epoxy resin, and urethane modified bisphenol-A epoxy resin.
